(19) United States
(12) Patent Application Publication
(10) Pub. No.: US 2025/0010289 A1
(43) Pub. Date: Jan. 9, 2025

(54) CARTRIDGE FOR A ROTATION-BASED ANALYSIS METHOD WHICH UTILIZES A HEAT INPUT

(71) Applicant: Endress+Hauser BioSense AG, Freiburg (DE)

(72) Inventor: Jürgen Baumgartl, Treuchtlingen (DE)

(21) Appl. No.: 18/710,262

(22) PCT Filed: Nov. 11, 2022
(86) PCT No.: PCT/EP2022/081644

§ 371 Date: May 15, 2024

(30) Foreign Application Priority Data
Nov. 16, 2021 (DE) 10 2021 212 886.6

(51) Int. Cl. B01L 3/00

(52) U.S. Cl. CPC B01L 3/502715; B01L 3/502707; B01L 2300/041; B01L 2300/18

(57) ABSTRACT

A cartridge for a rotation-based analysis method includes a base body, in which a channel and chamber structure is formed, and a cover body, which is secured to the base body and covers a chamber of the base body. The base body and/or the cover body include a number of holding openings and corresponding, complementary latching hooks, each including a foot limb protruding in the direction of the corresponding base body or the cover body, wherein the foot limb transitions into a central part bent in a U-shaped manner, which transitions into a free limb oriented toward the respective cover body or the base body. Each latching hook includes a projection with a latching surface on the end of the free limb. The central part of each latching hook engages through the corresponding paired holding opening, thereby forming a latching connection in the assembled state.

The invention relates to a cartridge for a rotation-based analysis method which utilizes a heat input.

Rotation-based analysis methods are applied in the medical field using so-called cartridges which have one, often microfluidic, channel and chamber structure. They are usually used to analyze genetic material, usually in the form of DNA (deoxyribonucleic acid) or RNA (ribonucleic acid), in addition to scientific genetic material analyses and the like, to examine for the presence of diseases or to detect said genetic material in the first place to identify pathogens. For this purpose, starting from a sample, e.g., a smear, a blood sample, or the like, specific regions contained in the genetic material (DNA or RNA) must be amplified. In the case of the detection or analysis of RNA in a sample (e.g., for detection of a virus), it is first transcribed into DNA by so-called “reverse transcription” and then amplified.

To amplify the DNA, the so-called polymerase chain reaction (PCR for short) is usually applied in a liquid reaction mixture. The DNA is typically present in the form of a double helix structure consisting of two individual complementary DNA strands. During PCR, the DNA is first separated into two individual strands by an increased temperature of the liquid reaction mixture typically between 90-96 degrees Celsius (“denaturation phase”).

The temperature is then reduced again (“annealing phase,” typically in a range of 50-70° C.) in order to allow a specific accumulation of so-called primer molecules on the individual strands. The primer molecules are complementary, short DNA strands that bind at a defined location to the individual strands of the DNA. The primer molecules (also called “primers” for short) serve as a starting point for an enzyme, the so-called polymerase, which in the so-called elongation phase fills in the basic building blocks (“dNTPs”) complementarily to the present DNA sequence of the individual strand. In this case, starting from the primer molecule, a double-stranded DNA is again produced. The elongation is typically carried out at the same temperature as in the annealing phase or at a slightly increased temperature, typically between 65 and 75° C. After the elongation, the temperature is increased again for the denaturing phase.

This cycling of the temperature in the liquid reaction mixture between the two to three temperature ranges is called “PCR thermal cycling” and is typically repeated in 30 and 50 cycles. In each cycle, the specific DNA range is amplified. Typically, the thermal cycling of the liquid reaction mixture is implemented in a reaction vessel by controlling the external temperature. The reaction vessel is located in this case, for example, in a thermal cycler in which the PCR thermal cycling is implemented by heating and cooling a solid body which is in thermal contact with the reaction vessel, and heat is thereby supplied to and removed from the liquid. Alternative heating and cooling concepts for implementing the PCR thermal cycling are, inter alia, the temperature control of fluids (in particular air and water) which flow around the reaction vessel and radiation-based concepts, for example, by introducing heat using IR radiation or laser radiation. In the case of the rotation-based method, a chamber, for example, in the aforementioned cartridge is used as a reaction vessel and correspondingly heated. In addition, the cartridge, which is usually designed like a disk, is rotated.

As an alternative to the PCR thermal cycling described above, methods, such as isothermal amplification and isothermal immunoassays, are also used as methods for analyzing (amplifying) DNA (or RNA) or for examining for diseases.

In some cases, the cartridge also has “add-on parts” which serve for stabilization, for better handling or also for support of the temperature control. However, due to the often high rotational speed and/or temperature effect, these add-on parts can become (at least partially) detached.

The object of the invention is to provide an improved cartridge.

This object is achieved according to the invention by a cartridge which is set up and provided for a rotation-based analysis method and which has the features of claim 1. Embodiments and developments of the invention which are advantageous and some of which are inventive in themselves are set forth in the dependent claims and the following description.

The cartridge according to the invention is set up and provided for use in a rotation-based analysis method which utilizes a, preferably one-sided, heat input. For this purpose, the cartridge has a base body, which extends in a planar manner, i.e., in particular substantially two-dimensionally and in which an in particular microfluidic channel and chamber structure is formed, in the context of which a plurality of (processing) chambers are preferably connected to one another by means of channels.

Furthermore, the cartridge has a cover body, which is secured to the base body and is arranged on one side on a base body upper face facing away from a heat input side and which covers at least one (“processing”) chamber of the channel and chamber structure of the base body. The base body and/or the cover body have a number of holding openings. The cover body or the base body (e.g., accordingly vice versa) has a number of latching hooks, each of which is paired with one of the optionally multiple holding openings. A (preferably straight and elongated) “foot limb” of the (or in the case of a plurality of latching hooks, each) latching hook in this case protrudes from the cover body or the base body in the direction of the corresponding other component (i.e., the base body or the cover body). Consequently, the foot limb “stands” on the cover body or the base body. The foot limb transitions into a central part which is bent in a U-shaped manner and in turn transitions into a (preferably straight and elongated) free limb. This free limb is oriented back in the direction of the cover body or the base body and terminates with a free end. The latching hook (or each latching hook) also has a projection with a latching surface on the free end-side, said latching surface (i.e., a normal pointing from the latching surface into the surroundings) being oriented in the direction of the free end. The U-shaped curved central part of the latching hook (or of each latching hook) engages (in the intended assembled state of the cartridge) through the paired holding opening, thereby forming the latching connection.

Compared to a conventional latching hook, the latching hook according to the invention (at least its free end) is advantageously not (or at least not substantially) subjected to tensile stress when the cover body is loaded in the disassembly direction, but rather is subjected to pressure and possibly also to bending and/or shearing. This leads to different (elastic and possibly plastic) deformation behavior, which advantageously makes “unclipping,”, an (in particular undesired) detachment of the latching surface from its counterpart more difficult. Even in the case of a load in the surface direction of the base body and in particular also of the cover body, a deformation counteracting a detachment of the connection is thus advantageously allowed. Such a load can occur, for example, due to different thermal expansions of the cover body and the base body and/or due to centrifugal forces during rotation.

“Microfluidic” is understood in particular to mean a structure which is set up and provided for guiding a fluid and its smallest spatial extension (e.g., the width and/or depth of a channel or a chamber) is in the range of less than one millimeter.

Particularly preferably, the foot limb and the free limb are at an angle greater than zero and less than 90 degrees (preferably less than 60, preferably less than 45 degrees) relative to one another. When viewed along the surface of the base body or cover body, an at least imaginary triangle, in particular open on one limb (the free limb), results in this case. If the open limb of the triangle is now loaded, the foot limb connected thereto is also displaced. Due to this mechanical linkage, at least in the event of a load, an advantageous expansion of the latching hook in the holding opening results, which can lead to an increase in the latching effect rather than to the reduction thereof or even to detachment.

Optionally, the “triangular plane,” i.e., the plane spanned by the foot limb and the free limb, of the latching hook (or each latching hook) is oriented in an expected load direction, in particular in a centrifugal force direction. In particular, this at least usually causes a load on the latching hook which leads to a deflection of the free limb in the direction of the foot limb (or vice versa). Due to the above linkage of these two limbs, the latching effect is thereby even promoted, for example since such a deflection can lead to a clamping of the two limbs against one another. Alternatively, a plurality of latching hooks is present, which are each set differently against the centrifugal force direction.

In an expedient embodiment, the holding opening (or each holding opening) has a contact surface, against which the rear side (facing away from the free limb) of the foot limb rests at least partially. Alternatively, the rear side can also be at a small distance from the contact surface. A small distance is understood here to mean a distance value which is small with respect to the thickness (i.e., the cross section) of the latching hook, to the spring travel or the like. This small distance thus represents in particular a slight play of the latching hook in the holding opening. As a result of the contact or the small distance, slight movement of the cover body and the base body relative to one another can thus advantageously lead to deformation and thus advantageously to an additional expansion of the latching hook in the holding opening.

In a further expedient embodiment, a contact protrusion (also referred to as a “nib”) protrudes on the rear side of the latching hook, preferably at the transition of the foot limb to the central part. This nib is designed in such a way that the rear side is “lengthened” (in particular with respect to an imaginary or “ideal” curvature of the central part) and optionally also protrudes in the region of the nib in the direction of the contact surface. As a result, the latching hook can be even better supported on the contact surface and in particular wedged against the contact surface when loaded in the disassembly direction.

In an optional embodiment, the rear side of the latching hook also has a bump protruding toward the outside. This thus forms a wave-like elevation on the rear side. In this case, the length of the wave is short, for example, multiple times (for example, 3 or 5 times) smaller, compared to the length of the foot limb. This bump serves in particular as a demolding aid for the preferably injection-molded production of the cover body. The bump advantageously prevents the latching hook from being demolded prematurely, which could lead to undesired deformation. In addition, the bump can advantageously initiate contact between the contact surface and the latching hook. Optionally, in the intended assembled state not loaded by external effects, there is already contact between the bump and the contact surface.

In a preferred embodiment, the latching surface of the latching hook rests against a latching shoulder. This latching shoulder protrudes into the holding opening, in particular from a latching side of the holding opening opposite the contact surface.

The latching hook or each latching hook is preferably clamped in the holding opening in the intended, unloaded assembled state. In particular, the latching hook rests with the rear side and with the front side (i.e., with its latching surface) on the contact surface or the latching shoulder of the holding opening and is thereby deformed at least slightly elastically. As a result, a slight displacement of the cover body relative to the base body can already lead to the above-described deflection of the latching hook. “Rattling” of the cover body due to a loose fit can thus be effectively prevented, so that a high-quality impression can be achieved.

In an expedient embodiment, the holding opening or each holding opening is formed in a holding dome protruding from the base body or the cover body in the direction of the corresponding other component. This is expedient in particular for cases in which both the base body and the cover body are designed with comparatively thin walls but a predetermined distance between the two must be maintained. The holding dome can function as a spacer, for example. The latching shoulder described above is preferably formed at the end facing the opposite component. As a result, the central part, which is curved in a U-shaped manner, of the latching hook can remain within the holding dome without projecting at the opposite (rear) side of the base body or of the cover body. As a result, this side of the base body or of the cover body can be provided with a sticker, for example a label, or the like without it bulging.

In an expedient development, the cover body or the base body (in any case the body which also has the latching hook) has at least one, in particular rib-like, protrusion. This is preferably paired with one of the optionally plurality of latching hooks and arranged adjacent to it. In the intended assembled state, the protrusion engages on the outside for centering against the holding dome, i.e., rests against the holding dome. The protrusion serves as an insertion aid (for inserting the latching hook into the holding opening) and/or as a displacement inhibitor during operation. In the latter case, the protrusion resting against the holding dome reduces or prevents a displacement of the holding dome on the latching hook. In the event that the base body or the cover body has a plurality of holding openings and the cover body or the base body correspondingly conversely has a plurality of latching hooks, a plurality of projections paired with the corresponding latching hooks can particularly effectively prevent a displacement of the cover body relative to the base body (in particular in the case of differently oriented contact normals between holding domes and projections).

In a preferred embodiment, the (processing) chamber covered by the cover body is an amplification chamber, in particular a so-called pre-amplification chamber, for amplifying genetic material. In such a pre-amplification chamber, genetic material contained in a sample is amplified in order to have available a sufficient amount of genetic material for different testing methods (for example, further amplifications) or for a statistically sufficiently secure examination in a later method step.

In an expedient embodiment, the cover body covers the upper face of the base body at least approximately completely (i.e., in particular all chambers and channels).

In an advantageous embodiment, the cover body has a frame web protruding in the direction of the upper face of the base body and encircling the covered chamber, in particular the above-mentioned amplification chamber. This prevents or largely reduces convection parallel to the surface of the base body, in particular, thus, an air flow running between the surface of the base body and the cover body, at least over the chamber to be covered, preferably the above-mentioned (pre-) amplification chamber. A particularly high homogeneity of the temperature (or, expressed in other words, a particularly low temperature deviation) within the chamber can thereby be achieved (in the case of a “quasi-stationary” state, in particular after a comparatively long hold time of the processing parameters, i.e., heating temperature and rotational speed, of, for example, 30 seconds). In particular, temperature differences below 10 Kelvin, preferably below 5 Kelvin, in particular around approximately 2 Kelvin, can be achieved.

The base body of the cartridge is preferably formed from an, in particular thermoplastic, substrate, into which the channel and chamber structure is shaped, and a sealing layer, in particular a sealing film, which is fixedly connected to the substrate after a sealing step and thus closes the channel and chamber structure.

In a further preferred embodiment, the base body is formed from a cyclic olefin copolymer (COC) and the cover body from another, in particular thermoplastic, plastic, preferably a polypropylene (PP). Preferably, the latching hook is shaped on the cover body, since its material has more favorable properties than that of the base body with regard to the deformation capability.

Here and below, the conjunction “and/or” is to be understood in particular such that the features linked by means of this conjunction can be designed both together and as alternatives to one another.

Exemplary embodiments of the invention are explained in more detail below with reference to a drawing. In the drawings:

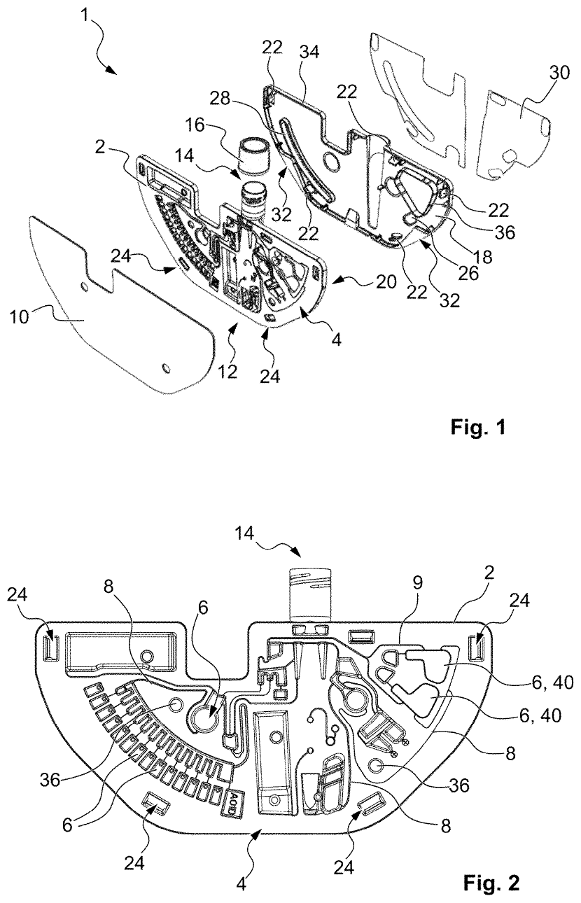

FIG. 1 shows a schematic exploded view of a cartridge for use in a rotation-based analysis method,

FIG. 2 shows a schematic plan view of a heat input side of a base body of the cartridge,

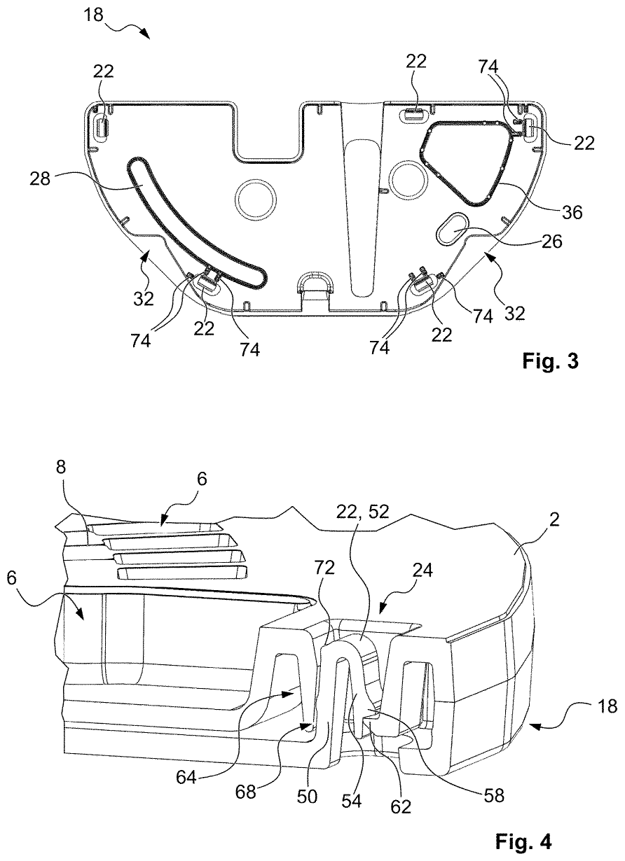

FIG. 3 shows a schematic view of an underside of a cover body of the cartridge,

FIG. 4 shows a perspective partial sectional view, as a cutout section and schematically, of a connection point between the base body and the cover body,

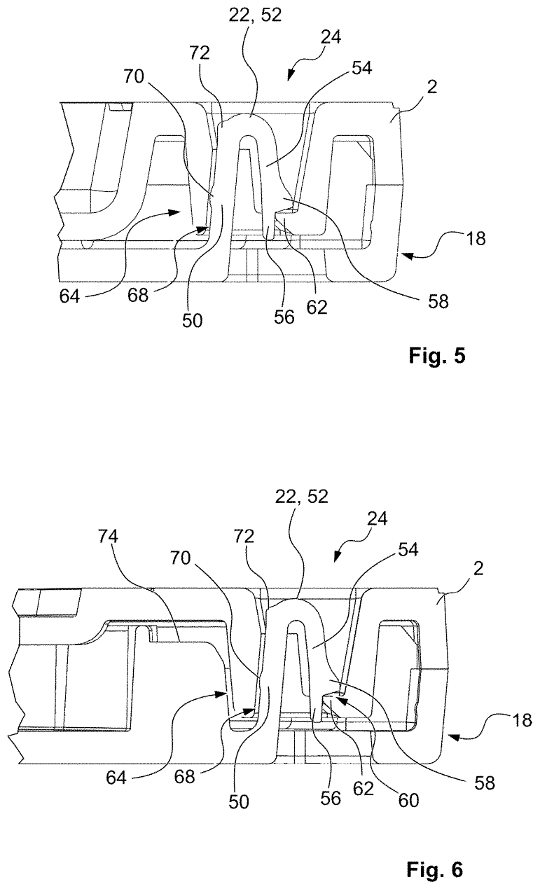

FIG. 5, 6 show a partial sectional view, as a cutout section and schematically, of the connection point of two different exemplary embodiments, and

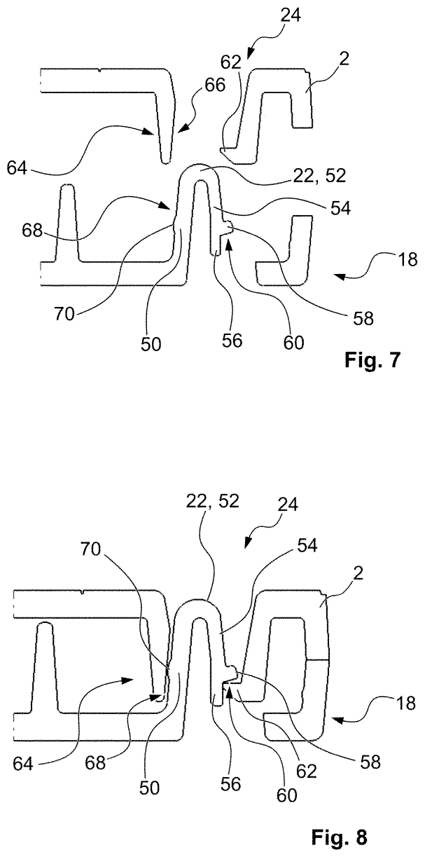

FIG. 7, 8 show a view according to FIG. 5, in each case schematically, of an unassembled and an assembled state of the base body and cover body.

Corresponding parts are always provided with the same reference signs in all the figures.

FIG. 1 schematically shows a sample container referred to as a “cartridge,” or, due to the flat geometry approximating a halved circular disk, as “disk 1” for short. This disk 1 serves for use in a rotation-based analysis method. The disk 1 has a base body 2 (also referred to as a “substrate”), which has a microfluidic channel and chamber structure 4.

This channel and chamber structure 4 in turn has a plurality of chambers 6 described in more detail below, which are connected to one another by means of paired channels 8 (see FIG. 2). In the unassembled state, the chambers 6 and channels 8 each form “open,” flanged or groove-like indentations in the base body 2. The disk 1 therefore also has a sealing film 10 (or also: “sealing layer”) which is hot sealed to the microfluidic base body 2 and thus closes the channel and chamber structure 4 from a side referred to below as the “heat input side 12” (see FIG. 1). The base body 2 has a lateral access 14 to the channel and chamber structure 4 through which sample material can be introduced into the channel and chamber structure 4. This access 14 can be reversibly closed by means of a cap 16 (here specifically a screw cap) in order to allow the introduction of the sample material and subsequent re-closing. The disk 1 also has a cover body, referred to below as “cover 18” for short, which is placed on the base body 2 on an “upper face 20” (or also “on the rear side” in relation to the heat input side 12) and is fixed to the base body in the present embodiment by means of latching hooks 22 (only indicated in FIG. 1, shown in detail in FIG. 4-8) in corresponding holding openings 24 of the base body 2. The cover 18 has a first and a second readout window 26 or 28, through which the contents of the chambers 6 of the base body 2 located underneath can be read out and thus analyzed (for example, by means of fluorescence detection) or at least can be monitored.

In an optional variant (shown here), the disk 1 also has a (here two-part, preferably self-adhesive) label 30 which is applied to the cover 18. The label 30 is designed such that it allows the readout through the readout windows 26 and 28. In an optional development of this variant, the label 30 has transparent regions which cover the readout windows 26 and 28. These transparent regions are expediently not provided with adhesive, i.e., adhesive is not used, so that the fluorescence detection is not influenced by adhesive that may be luminescent.

In the cover 18, recesses 32 are shaped laterally in a side wall 34, which allow an alignment and positioning of the disk 1 in an automatic intake of an analysis device.

The base body 2 has a plurality of (here specifically two) openings 36 which serve for the unambiguous alignment and positioning of the disk 1 on a support plate (referred to below as a “rotary plate”) of the analysis device. Position pins of the rotary plate engage in these openings 36 for positioning and fixing in a rotary plane which lies parallel to the surface of the rotary plate and to the heat input side 12 (and thus to the planar extension) of the disk 1.

The rotary plate of the analysis device serves for centrifugation, i.e., for rotation of the disk 1 about an axis of rotation. The rotary plate is thereby set up to be able to receive optionally two disks 1 and is therefore constructed rotationally symmetrically by 180 degrees (see FIG. 3). In addition, the rotary plate carries a plurality of heating elements which serve to locally heat individual chambers 6 of the channel and chamber structure 4 of the disk 1 and therefore are adapted in their outer contour to the corresponding chambers 6. In the present case, the heating elements are formed by resistance heating plates.

For further reduction of the heat output, in a further exemplary embodiment, the cover has a frame web 38 which annularly surrounds the pre-amplification chambers 56 and thus further reduces the heat output by convection on the upper face 20 (see FIGS. 1 and 3). The frame web 38 is molded onto the cover 18, i.e., integrally connected thereto. The frame web 38 protrudes in the direction of the base body 2 and ends at a small distance of approximately 100 μm from the base body 2. In this case, the frame web 38 surrounds two chambers 6 serving as pre-amplification chambers 40. This continued shielding of the pre-amplification chambers 40 by the cover 18 and the frame web 38 allows a temperature difference of about 2 Kelvin within the corresponding pre-amplification chamber 40. A comparatively strong convection thus takes place in the corresponding pre-amplification chamber 40, inter alia due to the rotation. In addition, however, a comparatively high homogeneity of the reaction temperature within the pre-amplification chamber 40 is also achieved, at least in the static case, i.e., when the temperature of the heating element is held for at least about 10 to 30 seconds. With the geometry described here and below and the parameters applied in this case, experiential values have shown that static conditions result starting from about 15 seconds.

Even in the event that a reaction takes place in the pre-amplification chambers 40 which requires an interaction, for example, a binding of molecules to a solid phase, e.g., to microarrays, or a reaction in which the concentration of each of the reactants is usually low and therefore contact of the corresponding reactants with one another is subject to a comparatively low probability, the high convection (and thus comparatively strong mixing) and the homogeneous temperature distribution can be advantageous.

The latching hook 22 and the holding opening 24 are shown in more detail in FIGS. 4 to 6. In this case, the latching hook 22 is basically U-shaped. Specifically, the latching hook has a straight, elongated (i.e., long in comparison with its thickness and/or width) foot limb 50. This foot limb 50 stands on the cover 18 (i.e., is attached to the cover 18) and protrudes from it, tilted slightly in relation to a surface normal, i.e., at an angle of less than 90 degrees but greater than 60 degrees, preferably greater than 70 degrees, in the direction of the base body 2. The latching hook 22 also has a U-shaped curved central part 52 and a (straight, elongated) free limb 54. The foot limb 50 thereby transitions into the central part 52, which in turn transitions into the free limb 54. The latter ends with a free end 56 (i.e., without connection to a further component). The foot limb 50 and the free limb 54 enclose an angle of about 5 to 20 degrees, here specifically between 7 and 12 degrees. At the free end, the latching hook has a projection 58, on which a latching surface 60 (see FIG. 7-8), which faces the free end 56 and thus back toward the cover 18, is formed.

In the intended assembled state shown in FIGS. 4-6 and 8, the latching hook 22 rests against a latching shoulder 62 of the holding opening 24 in order to form the latch with this latching surface 60. In addition, the central part 52 of the latching hook 22 engages through the holding opening 24 (at least its cover-side “mouth”). To assemble the cover 18 on the base body 2, the free limb 54 and the foot limb 50 thus have to be bent relative to one another.

The holding opening 24 is formed within a protrusion of the base body 2 designed as a type of tower or “dome” (referred to here as “holding dome” 64). The latching shoulder 62 thereby projects in a limiting manner into the cover-side “mouth” of the holding opening 24. The holding dome 64 and the latching hook 22 are dimensioned in such a way that the latching hook 22 does not protrude out of the rear side of the holding opening 24 and thus the holding dome 64. The “clear width” of the cover-side mouth of the holding opening 24 is dimensioned such that the above-mentioned bending of the latching hook 22 remains in the elastic deformation range during assembly.

The holding opening 24 also has a contact surface 66 which is arranged opposite the latching shoulder 62. This contact surface 66 is inclined as a type of insertion bevel in a manner that widens the holding opening 24 in the direction of the cover-side mouth. In addition, the contact surface 66 also serves as a type of abutment for the latching hook 22, a rear side 68 of the foot limb 50 of which rests against the contact surface in the intended assembled state.

In the exemplary embodiments shown, a bump 70 is formed on the rear side 68 of the foot limb 50. During the production of the cover 18 in a plastic injection molding process, this is used as a demolding aid, specifically as a type of retention element, which prevents the latching hook 22 from being “prematurely” demolded during an adjustment of a movable mold core and thereby being undesirably deformed.

In the exemplary embodiments shown, the latching hook 22 is clamped in the holding opening 24, i.e., between the latching shoulder 62 and the contact surface 66, in the intended, unloaded assembled state (see FIGS. 4 and 6). In principle, however, a slight play relative to the contact surface 66 can also be present.

In the exemplary embodiment according to FIGS. 7 and 8, the latching hook 22 is designed to be smooth on the outside in the region of the central part 52. In the exemplary embodiments shown in FIG. 4-6, the rear side 68 of the latching hook 22 has, at the transition from the foot limb 50 to the central part 52, a “nib” 72 which extends the surface (or “length”) of the rear side 68 in the longitudinal direction of the latching hook 22 (compared to FIGS. 7 and 8). When the latching hook 22 is pulled out of the holding opening 24 without the latching surface 60 being “decoupled” from the latching shoulder 62, this nib 72 causes the latching hook 22 to rest for longer against the contact surface 66 and thus the latching hook 22 can be “wedged” comparatively strongly.

Due to the geometry of the latching hook 22 described here, a displacement of the cover 18 relative to the base body 2 in the direction of the plane spanned by the foot limb 50 and the free limb 54 (i.e., in FIG. 5-8 the plane of the drawing) leads to a further clamping of the latching hook 22 in the holding opening, which enhances the latching effect of the latching surface 60 on the latching shoulder 62 even further. An unintentional detachment of this latching connection during operation of the analysis device, i.e., under the action of increased temperature and centrifugal force, can thereby be effectively prevented.

FIG. 6 shows a further exemplary embodiment. In this case, the cover 18 has at least one protrusion, referred to here as “guide rib 74,” locally in addition to at least some latching hooks 22. This guide rib 74 is formed adjacent to the corresponding latching hook 22 and pointing in the same direction. Furthermore, the corresponding guide rib 74 is oriented in such a way that its longitudinal extension is aligned, at least approximately, normal to the outside of the corresponding holding dome 64 (see FIG. 3). The guide ribs 74 serve both as centering, for example an insertion aid, in order to be able to insert the corresponding latching hook 22 into the holding opening 24 of the corresponding holding dome 64 without jamming as far as possible. In the assembled state (see FIG. 6), the corresponding guide rib 74, due to its contact with the holding dome 64 or its slight distance from it (cf. FIG. 6), serves as an inhibitor or stop to prevent displacement of the cover 18 relative to the base body 2.

The subject matter of the invention is not limited to the exemplary embodiments described above. Rather, further embodiments of the invention can be derived from the above description by a person skilled in the art. In particular, the individual features of the invention and their design variants described with reference to the different exemplary embodiments can also be combined with one another in another way.

### LIST OF REFERENCE SIGNS

1 Disk
2 Base body
4 Channel and chamber structure
6 Chamber
8 Channel
10 Sealing film
12 Heat input side
14 Access
16 Cap
18 Cover
20 Upper face
22 Latching hook
24 Holding opening
26 Readout window
27 Readout window
30 Label
32 Recess
Side wall
36 Opening
38 Frame web
40 Pre-amplification chamber
50 Foot limb
52 Central part
54 Free limb
56 Free end
58 Projection
60 Latching surface
62 Latching shoulder
64 Holding dome
66 Contact surface
68 Rear side
70 Bump
72 Nib
74 Guide rib

1-11. (canceled)

12. A cartridge for a rotation-based analysis method utilizing a heat input, the cartridge comprising:
a base body, which extends in a planar manner and which includes a channel and chamber structure formed therein, wherein the base body includes a rear side and an opposite, heat input side; and
a cover body attached to the base body, wherein the cover body is arranged on the rear side of the base body and covers at least one chamber of the base body,
wherein the base body and/or the cover body includes at least one holding opening, and wherein the cover body and/or the base body includes at least one corresponding latching hook, each of which is paired with a corresponding holding opening of the at least one holding opening,
wherein each latching hook includes a foot limb, which protrudes from its cover body or the base body in a direction of the corresponding base body or the cover body, wherein the foot limb transitions into a central portion, which is bent in a U-shaped manner, and which further transitions into a free limb, terminating at a free end, which free limb is oriented back in a direction of its cover body or the base body from which the foot limb protrudes,
wherein each latching hook includes a projection with a latching surface on the free end, the latching surface oriented toward the free end, and
wherein the central portion, which is bent in the U-shaped manner, engages through the corresponding holding opening, thereby forming a latching connection in an assembled state.

13. The cartridge according to claim 12, wherein each holding opening includes a contact surface on which a rear side of the foot limb rests at least partially or from which the rear side of the foot limb has a small distance.

14. The cartridge according to claim 13, wherein a contact protrusion protrudes on the rear side of each latching hook.

15. The cartridge according to claim 14, wherein the contact protrusion protrudes at a transition of the foot limb to the central portion.

16. The cartridge according to claim 12, wherein the latching surface of each latching hook rests against a latching shoulder which protrudes from a latching side opposite the contact surface and into the corresponding holding opening.

17. The cartridge according to claim 12, wherein each latching hook is clamped in the corresponding holding opening.

18. The cartridge according to claim 12, wherein each holding opening is formed in a holding dome protruding from its respective base body or the cover body in a direction of its corresponding cover body or base body.

19. The cartridge according to claim 18, wherein the corresponding cover body or base body includes at least one protrusion which engages a perimeter of the holding dome, wherein the at least one protrusion is adapted to center the respective latching hook in its corresponding holding opening so as to facilitate insertion therein.

20. The cartridge according to claim 12, wherein the at least one chamber of the base body covered by the cover body is an amplification chamber configured for amplifying genetic material.

21. The cartridge according to claim 12, wherein the cover body includes a frame web protruding toward the rear side of the base body and encircling the covered chamber.

22. The cartridge according to claim 12, wherein the base body comprises a thermoplastic substrate with the channel and chamber structure inserted therein and a sealing layer by which the channel and chamber structure is sealed.

23. The cartridge according claim 12, wherein the base body is made of a cyclic olefin copolymer, and the cover body is made of another plastic material.

24. The cartridge according claim 12, wherein the plastic material of the cover body is a polypropylene.
